(19) United States
(12) Patent Application Publication
(10) Pub. No.: US 2012/0047907 A1
(43) Pub. Date: Mar. 1, 2012

(54) METHOD FOR OPERATING A COMBUSTION CHAMBER AND COMBUSTION CHAMBER

(75) Inventors: Martin ZAJADATZ, Kussaberg (DE); Douglas PENNELL, Windisch (CH); Klaus DÖBBELING, Windisch (CH)

(73) Assignee: ALSTOM Technology Ltd, Baden (CH)

(21) Appl. No.: 13/217,030

(22) Filed: Aug. 24, 2011

(30) Foreign Application Priority Data
Aug. 24, 2010 (EP) 10173910.0

(51) Int. Cl. F02C 9/34; F02C 3/30

(52) U.S. Cl. 60/773; 60/775; 60/39.3; 60/737; 60/733

(57) ABSTRACT

A combustion chamber and method for operating a combustion chamber are disclosed. The combustion chamber having at least a mixing device connected to a combustion device. The mixing device has a first fuel feeding stage, to inject fuel into the mixing device and mix the fuel with an oxidizer to then burn the fuel in the combustion device. The combustion device has a second fuel feeding stage to inject fuel into the combustion device. The fuel of the second stage is mixed with only an inert fluid to form a mixture that is then injected into the combustion chamber.

### RELATED APPLICATION

This application claims priority under 35 U.S.C. §119 to European Patent Application No. 10173910.0 filed in Europe on Aug. 24, 2010, the entire content of which is hereby incorporated by reference in its entirety.

### FIELD

The present disclosure relates to a combustion chamber, such as, a premix combustion chamber of a gas turbine, i.e. a combustion chamber into which a fuel already mixed with an oxidiser is fed.

### BACKGROUND INFORMATION

EP 0 797 051 discloses a premix combustion chamber having mixing devices made of a conical part with tangential slots for air supply and nozzles for fuel supply therein (first stage, gaseous fuel). In addition, a lance for fuel supply is provided (first stage, liquid fuel). A cylindrical part is connected downstream of the conical part.

These mixing devices can be connected to a combustion device wherein the mixture formed in the mixing devices burns.

In addition a plurality of nozzles is provided, around each mixing device through which air and fuel can be supplied into the combustion chamber (second stage).

During operation at full load, air and fuel needed for combustion are supplied partially via the first stage (e.g., the largest quantity) and partially via the second stage. This operation mode can cause a premix flame to be generated at the first stage, and a partially premixed flame at the second stage, with NOₓ, CO emissions and pulsations below the limits.

In contrast, during operation at partial load the fuel supplied via the first stage can be reduced, and the fuel supplied via the second stage can be maintained constant or increased. Thus, at partial load a large fraction of the fuel can be supplied via the second stage.

Because the second stage generates a partially premixed/diffusion flame (e.g., known to have a much higher temperature than a premix flame), a high NOₓ can be formed. Therefore, even if the NOₓ emissions are within the limits, they are higher than at full load.

In addition, since premix burners (first stage) can be operated close to the lean blow off (LBO, e.g., with a lean mixture, close to the extinction point), at partial load (e.g., low load) CO emissions and pulsations can be high.

### SUMMARY

An exemplary method having a first fuel feeding stage for operating a combustion chamber including at least one mixing device connected to a combustion device having a second fuel feeding stage, is disclosed. The method comprises mixing a fuel with an oxidiser to then burn it in the combustion device, injecting fuel in the combustion device through the second fuel feeding stage; and mixing the fuel of the second fuel feeding stage with an inert fluid to form a mixture that is then injected into the combustion device.

An exemplary combustion chamber is disclosed. The combustion chamber comprises at least one mixing device connected to a combustion device, wherein the at least one mixing device has at least a first fuel feeding stage, to inject fuel into the at least one mixing device and mix it with an oxidiser to then burn it in the combustion device, wherein the combustion device has at least a second fuel feeding stage to inject a fuel therein, wherein the second fuel feeding stage has at least a mixer receiving the fuel and an inert fluid to mix the fuel and the inert fluid and form a mixture that is then injected.

### BRIEF DESCRIPTION OF THE DRAWINGS

Further characteristics and advantages of the disclosure will be more apparent from the description of a preferred but non-exclusive embodiment of the method and combustion chamber illustrated by way of non-limiting example in the accompanying drawings, in which:

FIG. 1 illustrates a schematic view of a combustion chamber operating with gas fuel in accordance with an exemplary embodiment;

FIG. 2 illustrates a schematic view of a combustion chamber operating with liquid fuel (oil) in accordance with an exemplary embodiment;

FIG. 3 illustrates a diagram showing the relationship between pulsations and the second stage fuel ratio also called Pilot Fuel Ratio PFR, and NOₓ emissions and PFR in accordance with an exemplary embodiment; and

FIG. 4 illustrates a combustion chamber with six premixed nozzles which can be operated in a group or individually in accordance with an exemplary embodiment.

### DESCRIPTION

Exemplary embodiments of the present disclosure provide a method and a combustion chamber that permit an optimised operation, with reduced NOₓ and CO emissions and pulsations in a large load range and for a wide variety of fuels.

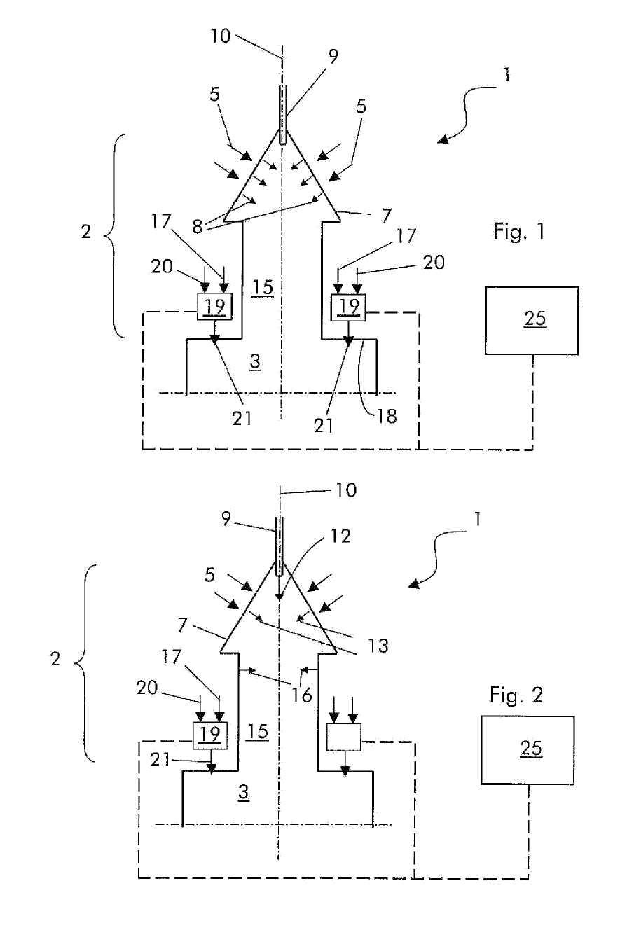

Each of FIGS. 1 and 2 illustrate exemplary combustion chambers. FIG. 1 illustrates a schematic view of a combustion chamber operating with gas fuel in accordance with an exemplary embodiment. FIG. 2 illustrates a schematic view of a combustion chamber operating with liquid fuel (e.g., oil) in accordance with an exemplary embodiment. As shown in FIG. 1, combustion chamber 1 (e.g., premixed type) can have at least a mixing device 2 connected to a combustion device 3. The combustion chamber 1 can be part of a gas turbine engine and can therefore be operatively connected to a compressor and one or more turbines.

The mixing device 2 can have a first fuel feeding stage, with nozzles to inject fuel into the mixing device and mix the fuel with an oxidiser 5 to then burn it in the combustion device 3.

In particular, the mixing device 2 has a substantially conical body 7 with tangential slots to allow the oxidiser 5 (e.g., air) to enter therein. The mixer also has nozzles at an end of the substantially conical body 7 for fuel 8 injection. This configuration represents the first stage during operation with gaseous fuel.

In addition, a lance 9 can be centrally provided, extending along a longitudinal axis 10 of the combustion chamber 1. The lance 9 can be provided with further nozzles for fuel 12 injection. This configuration represents the first stage during operation with liquid fuel.

The first stage can also include gaseous fuel 13 injection from the substantially conical body 7 together with the liquid fuel 12 injection from the lance and further nozzles operation.

Downstream of the substantially conical body 7, the mixing device 2 can have a mixing tube 15, through which the oxidiser 5 and fuel 8, 12, 13 of the first stage emerging from the body 7, pass with leads to further mixing before they enter the combustion device 3.

In an exemplary embodiment, further fuel 16 can be injected from the mixing tube 10. The combustion device 3 can have a second fuel feeding stage, to inject a fuel 17 directly into the combustion device 3. In particular, downstream of the mixing tube 15 the combustion chamber 1 can have a step with a front plate 18 delimiting the combustion device 3. The front plate 18 can have nozzles for injection of the fuel 17. These nozzles can be placed around (e.g., symmetrically around) the mixing device 2 (e.g., around the mixing tube 15). The nozzles of the second fuel feeding stage can be connected to a mixer 19 that receives the fuel 17 (second stage) and an inert fluid 20, and mixes them to form a mixture 21 that is then injected into the combustion chamber 1.

The inert fluid 20 is generally a fluid that does not react during mixing.

In other exemplary embodiments of the present disclosure the inert fluid can be a mixture of an inert fluid as defined in the following and for example oxygen or air, provided that for chemical reason (stochiometry) or temperature the inert fluid does not react with the fuel during mixing such a fuel may for example include only a small amount of oxygen, for example up to 4-5%. In another exemplary embodiment, the inert fluid can also not contain any oxidising component.

For example, the inert fluid can be an inert gaseous fluid, such as N₂, CO₂, water steam, etc. or combination thereof, these inert fluids can be used when the fuel is a gaseous fuel such as H₂, H₂ containing gases from gasification processes, hydrocarbons, etc. or an inert liquid fluid such as water. This inert fluid can be an inert liquid when the fuel is a liquid fuel such as diesel, fuel oil, kerosene, naphtha, ethanol, methanol, or other suitable fuel type as desired.

The combustion chamber can include a control unit 25. The control unit 25 can receive information about the gas turbine engine load and can be connected to the mixers 19 for regulating the relative amount of inert fluid 20 and fuel 17 in the mixture 21 according to the load of the gas turbine engine.

During operation at full load, the design amount of fuel 8, 12, 13, 16 via the first stage is introduced into the mixing device 2 generating a premixed flame with low NOₓ emissions. In addition, a design amount of second fuel 17 can also be introduced into the combustion device 3 generating a partial premix flame that stabilizes ignition of the fuel from the first stage to achieve low CO and UHC emissions.

Therefore global operation with low NOₓ, CO, UHC emissions can be achieved.

When the load of the gas turbine is reduced, the amount of fuel injected into the combustion chamber 1 can be reduced accordingly. In particular, the fuel 8, 12, 13, 16 of the first stage can be reduced, whereas the fuel 17 of the second stage can be kept constant or can be increased (i.e. the PFR is increased, wherein PFR is the ratio between the fuel 17 (i.e. fuel of the second stage) and the total fuel injected into the combustion chamber (fuel of the first and second stage, i.e. fuel 8, 12, 13, 16, 17).

Since the first stage (e.g., premixed stage) operates close to LBO (e.g., flame extinction), reduction of the fuel 8, 12, 13, 16 can cause pulsations, high CO and UHC emissions.

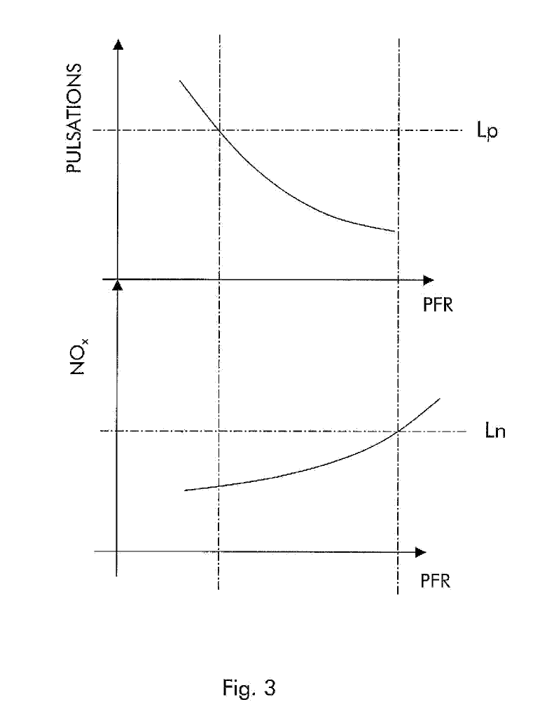

FIG. 3 illustrates a diagram showing the relationship between pulsations and the second stage fuel ratio also called Pilot Fuel Ratio PFR, and NOₓ emissions and PFR in accordance with an exemplary embodiment. As shown in FIG. 3, the larger the PFR, the lower the pulsations generated in the combustion chamber 1 and the larger the NOₓ emissions. Lp and Ln indicate the admissible limit for respectively pulsations and NOₓ.

It should be apparent that when the fuel 8, 12, 13, 16 of the first stage decreases, and the fuel 17 of the second stage is kept to a constant level or increased, which is the regulation implemented at part load, the PFR increases and the NOₓ emissions increase.

In addition, for highly reactive fuels such as H₂, H₂ containing gases from gasification processes, hydrocarbons, etc. (e.g., gaseous fuels) or diesel, fuel oil, kerosene, naphtha, ethanol, methanol, etc. (e.g., liquid fuels), combustion typically occurs rapidly as soon as the fuel 17 enters the combustion device 3, before it has the time to mix with the oxidizer 5.

The rapid combustion a can cause a diffusion flame to be generated and therefore a flame temperature very high with consequent further NOₓ generation. In order to control the NOₓ generation, the fuel (e.g., the fuel 17 of the second stage) is mixed with the inert fluid 20. Mixing the fuel with the insert fluid has two effects.

First, because the fuel 17 is diluted with an inert fluid (e.g., a fluid that does not take part in the combustion) the temperature of the gases generated by the fuel combustion is lower and, consequently the NOₓ generated are lower than in a case in which the fuel 17 is not mixed with an inert fluid (e.g., the higher the combustion temperature the higher the NOₓ emissions and vice versa).

Secondly, since inert fluid is mixed with the fuel 17, the oxygen concentration in the combustion area is reduced and therefore the reactivity which can depend on the temperature and oxygen concentration is lower than when only fuel or fuel mixed with air is injected.

Because the reactivity of the mixture of fuel and inert fluid is lower than pure fuel or mixture of fuel and air, the time required for combustion is higher and therefore a better mixing of the fuel with the oxidiser 5 can be achieved before combustion starts (e.g., a premixed flame or an almost premixed flame is generated that causes much less NOₓ emissions than a diffusion flame).

In addition, because the fuel 17 does not burn immediately after injection into the combustion device, combustion can be gradual and slower than when only fuel or fuel with air are injected. This circumstance can also allow the pulsations to be reduced.

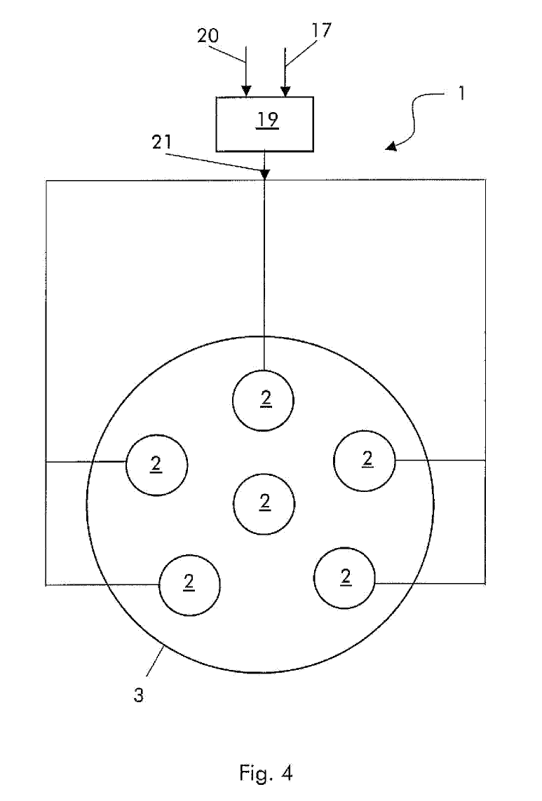

FIG. 4 illustrates a combustion chamber with six premixed nozzles which can be operated in a group or individually in accordance with an exemplary embodiment. As shown in FIG. 4, the combustion chamber 1 can be a can combustor.

The can combustor has six mixing devices 2 (e.g., the premixed nozzles) connected to a combustion device 3.

The mixing devices 2 define at least a first fuel feeding stage (e.g., the central nozzle defines such a first fuel feeding stage), and at least a second fuel feeding stage (e.g., the nozzles encircling the central nozzle define the second fuel feeding stage).

Also in this exemplary embodiment the second stage can have at least a mixer 19 receiving the fuel 17 and an inert fluid 20 to mix them and form a mixture 21 that is then injected into the combustion chamber 1.

An exemplary embodiment of the present disclosure also refers to a method for operating a combustion chamber 1 of a gas turbine with at least a first fuel feeding stage and a second fuel feeding stage.

The method includes mixing the fuel 17 of the second stage with an inert fluid 20 to form a mixture 21 that is then injected into the combustion chamber 1.

The relative amount of inert fluid 20 and fuel 17 in the mixture 21 can be regulated according to the load of the gas turbine.

In particular, at partial load the amount of inert fluid 20 within the mixture 21 can be larger than its amount in the mixture 20 at full load.

It should be understood that the suitable materials and dimensions used can be selected as desired according to specifications and to the state of the art.

Thus, it will be appreciated by those skilled in the art that the present disclosure can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE NUMBERS

1 combustion chamber

2 mixing device

3 combustion device

5 oxidiser

7 conical body

8 fuel

9 lance

10 axis

12 fuel

13 fuel

15 mixing tube

16 fuel

17 fuel

18 front plate

19 mixer

20 inert fluid

21 mixture

25 control unit

Lp admissible limit for pulsations

Ln admissible limit for NOₓ

What is claimed is:

1. A method for operating a combustion chamber including at least one mixing device having a first fuel feeding stage connected to a combustion device having a second fuel feeding stage, comprising:
mixing a fuel with an oxidiser to then burn it in the combustion device;
injecting fuel in the combustion device through the second fuel feeding stage; and
mixing the fuel of the second fuel feeding stage with an inert fluid to form a mixture that is then injected into the combustion device.

2. The method according to claim 1, wherein the inert fluid does not react during mixing.

3. The method according to claim 1, wherein the inert fluid does not contain any oxidising component.

4. The method according to claim 1, comprising regulating the relative amount of inert fluid and fuel in the mixture according to the load.

5. The method according to claim 4, wherein at part load the amount of inert fluid within the mixture is larger than the amount of inert fluid at full load.

6. The method according to claim 1, wherein the combustion chamber is part of a gas turbine engine.

7. A combustion chamber comprising:
at least one mixing device connected to a combustion device, wherein the at least one mixing device has at least a first fuel feeding stage, to inject fuel into the at least one mixing device and mix it with an oxidiser to then burn it in the combustion device, wherein the combustion device has at least a second fuel feeding stage to inject a fuel therein, wherein the second fuel feeding stage has at least a mixer receiving the fuel and an inert fluid to mix the fuel and the inert fluid and form a mixture that is then injected.

8. The combustion chamber according to claim 7, wherein the inert fluid does not react during mixing.

9. The combustion chamber according to claim 7, wherein the inert fluid does not contain any oxidising component.

10. The combustion chamber according to claim 7, comprising:
a control unit for receiving information about the load and connected to the mixer for regulating the relative amount of inert fluid and fuel in the mixture according to the load.

11. The combustion chamber according to claim 7, wherein the combustion chamber is part of a gas turbine engine.
